(19) United States
(12) Patent Application Publication
(10) Pub. No.: US 2003/0074359 A1
(43) Pub. Date: Apr. 17, 2003

(54) Network management unit

(76) Inventor: Koji Tezuka, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/083,761

(22) Filed: Feb. 26, 2002

(30) Foreign Application Priority Data
Oct. 12, 2001 (JP) 2001-315037

(51) Int. Cl. G06F 7/00

(52) U.S. Cl. 707/10

(57) ABSTRACT

A network management unit which builds and updates a network management model automatically and flexibly in accordance with changes made to the network of interest, so that network engineers can perform network management tasks more easily and efficiently. A network element information manager collects and manages network element information, including inner layer structure of each device constituting a network. A scenario manager manages scenarios for use in building a network management model. When a network construction request is received, a network management model builder builds or updates a network management model automatically, consulting the network element information in conjunction with an appropriate scenario retrieved from the scenario manager. The resultant network management model is saved in a network management model database.

### BACKGROUND OF THE INVENTION

1. Field of the Invention

The present invention relates to a network management unit, and particularly to a network management unit which manages configuration of networks.

2. Description of the Related Art

Today's network systems have increased in size and complexity to serve the diverse user needs for telecommunications services. This leads to a growing demand for element management systems (EMSs) in the hope of more efficient management of network elements (NEs) constituting a communications system.

In data communication networks, an end-to-end connection between customers, as well as between customers and service providers, is provided through two kinds of networks: trunk networks (or long-haul networks) and local access networks. Trunk networks refer to backbone networks operated by common carriers, while access networks are used to connect subscriber equipment or carrier equipment to a trunk network. To introduce expanded network functions and deploy new services, network operators are required to reconfigure such trunk and access facilities. Conventionally, this task is performed by knowledgeable network engineers who can set up EMSs with detailed parameters to make the new technology work on their networks. That is, conventional network management relies on manual updates of EMS database records.

Basically, EMSs are deployed to manage a single technology domain. Trunk networks are relatively homogeneous in terms of the variety of network technologies being employed. Some trunk systems use SDH and others apply IP, but it is unlikely to mix different technologies in a single trunk network.

Access networks, on the other hand, are often required to employ different technologies in a single system to meet the needs for multimedia applications and services developed in these years. Such heterogeneity brings, however, an increased complexity of network layer structure; for example, there may be such an IP network that is constructed over ATM networks which are based on an SDH infrastructure. While network elements are designed to provide each individual technology (e.g., equipment dedicated to SDH networks), it is not unusual in access networks to see an expanded network element which supports multiple technologies such as SDH, ATM, and IP in an integrated way.

As described above, there may be a variety of ways to combine network elements, which diversifies the layer structures of access networks. This makes the task of setting up EMSs in an access network more complicated than that in the trunk networks. While network engineers still could do it manually on the basis of their knowledge about layer structure of each access network, the conventional way of modeling a network architecture is neither easy nor efficient.

### SUMMARY OF THE INVENTION

In view of the foregoing, it is an object of the present invention to provide a network management unit which builds and updates a network management model automatically and flexibly in accordance with changes made to the network of interest, so that the user can perform network management tasks more easily and efficiently.

To accomplish the above object, according to the present invention, there is provided a network management unit which manages configuration of a network. This unit comprises the following elements: a network element information manager which collects and manages network element information, including layer structure of each network element; a scenario manager which manages scenarios for use in building a model of the network; a network management model builder which builds and updates a network management model automatically in response to a network construction request, consulting the network element information in conjunction with the scenarios; and a network management model database which stores and manages the network management model.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of a network management unit according to the present invention;

FIG. 2 is a flowchart showing how the proposed network management unit operates;

FIG. 3 shows an example of a network to which the present invention may be applied;

FIG. 4 shows an example of network configuration;

FIG. 5 shows a network management model for the network of FIG. 4;

FIG. 6 shows a situation where a new network element is added to the network of FIG. 4;

FIG. 7 shows an updated network management model after the network structure has changed;

FIGS. 8 and 9 show a sequence diagram which shows how the network management model of FIG. 7 is created;

FIG. 10 shows a situation where new network elements are added to the network of FIG. 6;

FIG. 11 shows an updated network management model after the network structure has changed in FIG. 10;

FIGS. 12 and 13 show a sequence diagram which shows how the network management model of FIG. 11 is created;

FIGS. 14 and 15 show another sequence diagram which shows how the network management model of FIG. 11 is created;

FIG. 16 shows a situation where the network structure of FIG. 10 has been changed;

FIGS. 17 and 18 show how the network management model is affected by the change;

FIGS. 19 and 20 show a sequence diagram which how the network management model of FIG. 18 is created;

FIG. 21 shows an example of a computer screen; and

FIG. 22 shows how the management database maintains its records.

### DESCRIPTION OF THE PREFERRED EMBODIMENTS

Preferred embodiments of the present invention will be described below with reference to the accompanying drawings.

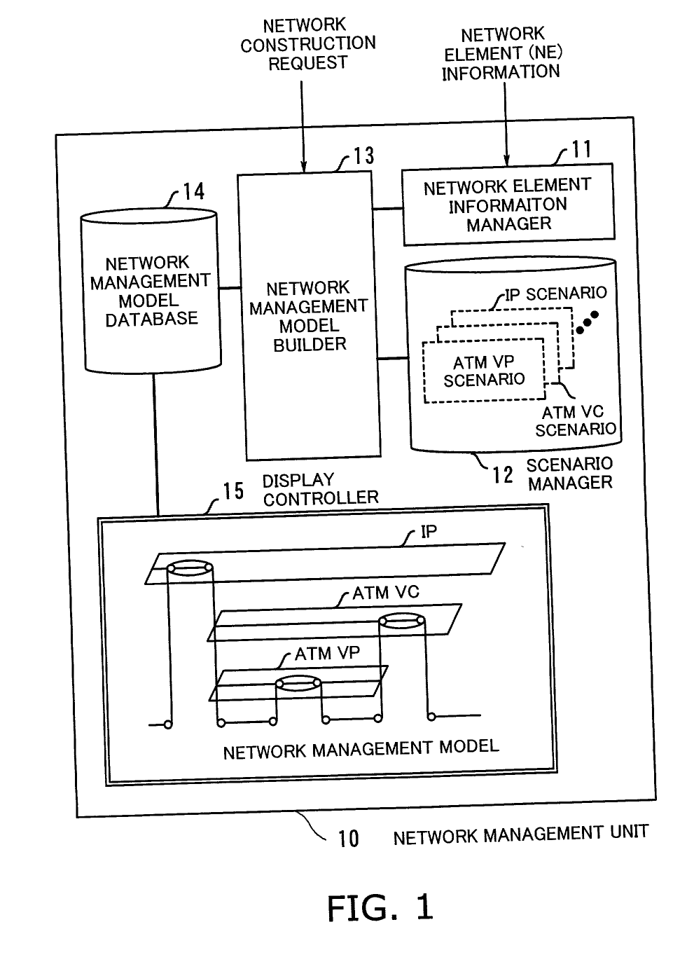

FIG. 1 is a conceptual view of a network management unit according to the present invention. The illustrated network management unit 10 manages configuration of a network, including update and expansion of network functions. To this end, the network management unit 10 comprises the following functional blocks: a network element information manager 11, a scenario manager 12, a network management model builder 13, a network management model database 14, and a display controller 15.

The network element information manager 11 collects and manages network element information, i.e., the information about the configuration of each network element, including layer structures thereof. The scenario manager 12 manages scenarios for use in building a network management model.

A higher-level system or an operator issues a network construction request, together with a piece of information specifying which part of the network has to be changed and how. The network management model builder 13 creates and updates a network management model automatically in response to the request, consulting the network element information provided from the network element information manager 11, in conjunction with appropriate scenarios retrieved from the scenario manager 12. Here, the network management model refers to an abstract, systematic representation of the structure of a specific network of interest.

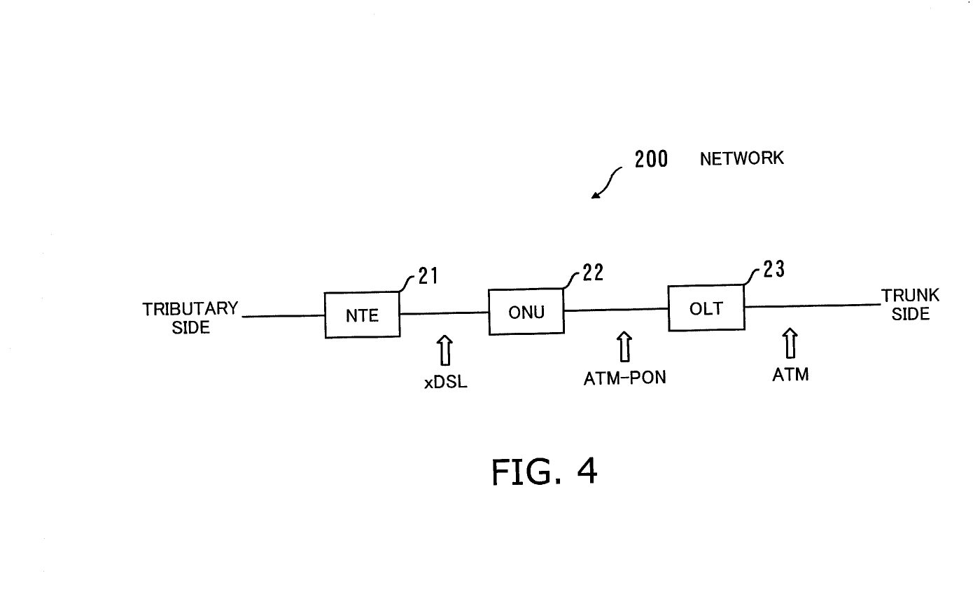

The network management model database 14 stores and manages the network management model produced and updated by the network management model builder 13. The display controller 15 displays the network management model in such a way that the user can see which part of the network has been changed or which part is failed. The procedure of creating a network management model will be described later with reference to FIG. 4 and subsequent figures.

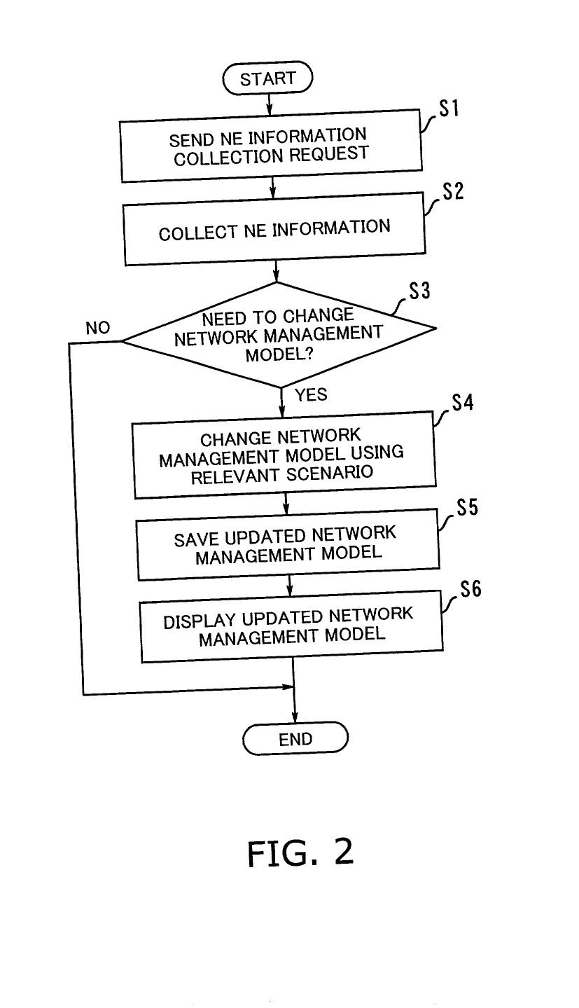

Referring now to the flowchart of FIG. 2, the total operation of the proposed network management unit 10 will be described below:

(S1) When a network construction request is received, the network management model builder 13 sends a network element information collection request to the network element information manager 11.

(S2) The network element information manager 11 interacts with relevant network elements to collect network element information describing both trunk and tributary sides of them. (The network management unit 10 may also be configured to previously obtain the information about layer configurations of network elements of interest.)

(S3) Based on the collected network element information, the network management model builder 13 examines the existing network management model in the network management model database 14. If there is a need to change the network management model, the process advances to step S4. If not, the process is terminated.

(S4) The network management model builder 13 consults the scenario manager 12 to retrieve an appropriate scenario for the change. With the retrieved scenario, the network management model builder 13 creates a new version of the network management model.

(S5) The network management model database 14 saves the updated network management model into its storage space.

(S6) The display controller 15 displays the updated network management model on a monitor screen.

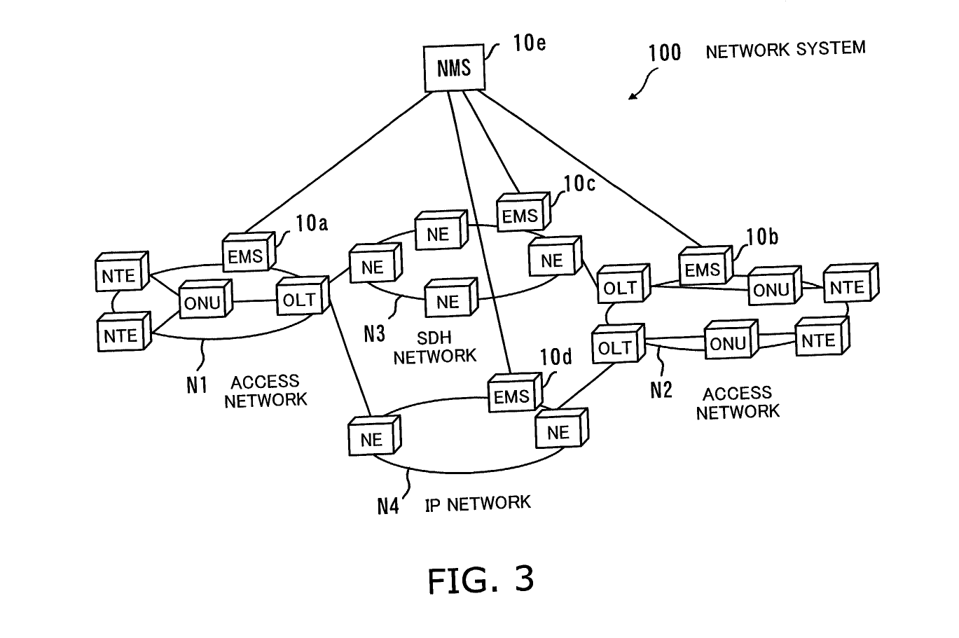

Referring next to FIG. 3, the following section will explain a network system in which the present invention is to be implemented. This network system 100 comprises access networks N1 and N2 on the edge side, and an SDH network N3 and IP network N4 on the core side.

An element management system (EMS) 10a to 10d is deployed in each individual network domain to provide element-level network management services. Typically, those EMSs 10a to 10d are the place where the network management unit 10 of the present invention is implemented.

The SDH network N3 accommodates network elements (NEs) designed for SDH transmission, thus formulating a single technology domain. Similarly, the IP network N4 accommodates its local NEs with IP functions, thus formulating another single technology domain. As such, the layer structures of these two networks N3 and N4 are homogeneous, and for this reason, their respective EMSs 10c and 10d are allowed to focus on either SDH-specific or IP-specific management activities.

Access networks N1 and N2, on the other hand, include different types of network elements, such as network termination equipment (NTE), optical network unit (ONU), and optical line termination (OLT). In those optical access network systems, NTEs and ONUs are linked through Ethernet (e.g., 10BASE-T, 100BASE-T), digital subscriber lines (xDSL), or the like, while ONUs and OLTs are interconnected by an optical interface such as ATM-PON (passive optical network). As seen from this example, the access networks N1 and N2 are heterogeneous environments where various technologies coexist, and accordingly, the EMSs 10a and 10b have to support multiple layer network configurations.

The EMSs 10a to 10d also communicate upward with a higher-level network management system (NMS) 10e. When there is a change in its global management domain, including addition or deletion in a specific network, the NMS 10e transmits a network construction request to the relevant EMS. In response to this, the requested EMS creates or updates a network management model of its own domain.

The above explanation has assumed that the present invention is embodied in the EMSs 10a to 10d, and the implemented network management units 10 create a network management model of their own domain. The present invention, however, is not limited to this configuration. The functions of the network management unit 10 may also be applied to the NMS 10e, in which case the NMS 10e would create individual models for all the networks N1 to N4 to make wide-area network management possible.

Referring next to FIG. 4 and subsequent drawings, more specific examples of network management models will be described. First, FIG. 4 shows a part of an access network 200, in which an NTE 21, an ONU 22, and an OLT 23 are connected in series. The NTE 21 and ONU 22 are interconnected by an xDSL link, while the ONU 22 and OLT 23 are interconnected by an ATM-PON network. The OLT 23 is connected to a trunk network with ATM interface. The NTE 21, ONU 22, and OLT 23 handle IP packets, ATM virtual path (VP) cells, and ATM virtual channel (VC) cells, respectively.

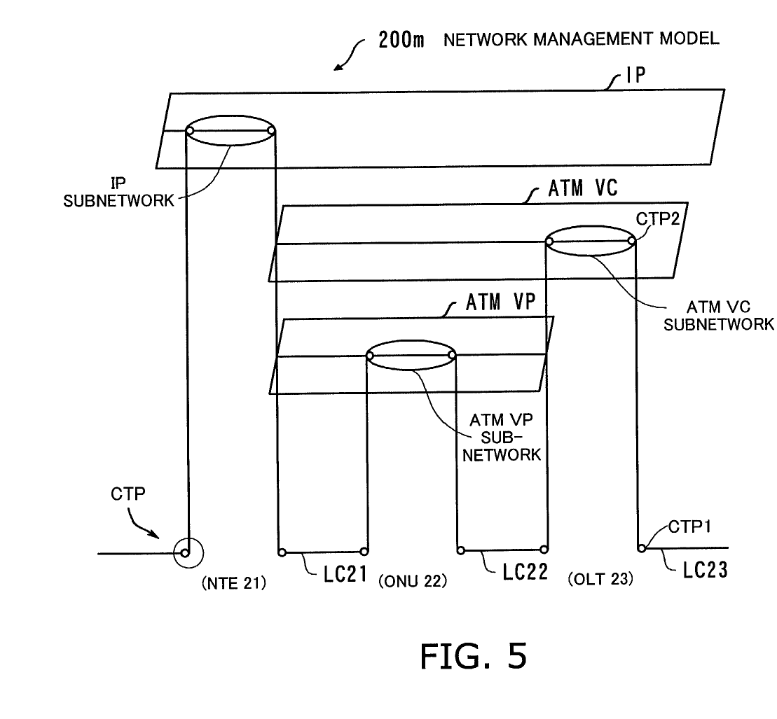

FIG. 5 shows a network management model 200m of the network 200, in which a plurality of layers are stacked in the vertical direction, and each layer (represented as a parallelogram extending in the horizontal direction) shows signal connections at that layer.

The bottommost portion of the network management model 200m represents the physical layer, where network elements are interconnected by “link connections.” More specifically, a link connection LC21 interconnects NTE 21 and ONU 22, while a link connection LC22 interconnects ONU 22 and OLT 23. Further, the OLT 23 has a link connection LC23 at its trunk-side port.

Every network element belongs to a management domain, called “subnetwork,” which enables each element to manage itself independently. More specifically, the NTE 21 is in an IP subnetwork, the ONU 22 is in an ATM VP subnetwork, and the OLT 23 is in an ATM VC subnetwork.

The network management model 200m of FIG. 5 also shows that the NTE 21 and OLT 23 have established an ATM VP-layer link connection via the ONU 22 located between them. Further, above that layer, there is an established ATM VC layer link connection between the NTE 21 and OLT 23. Small circles in FIG. 5 are called “connection termination points” (CTP), a data model of each network element's input/output port.

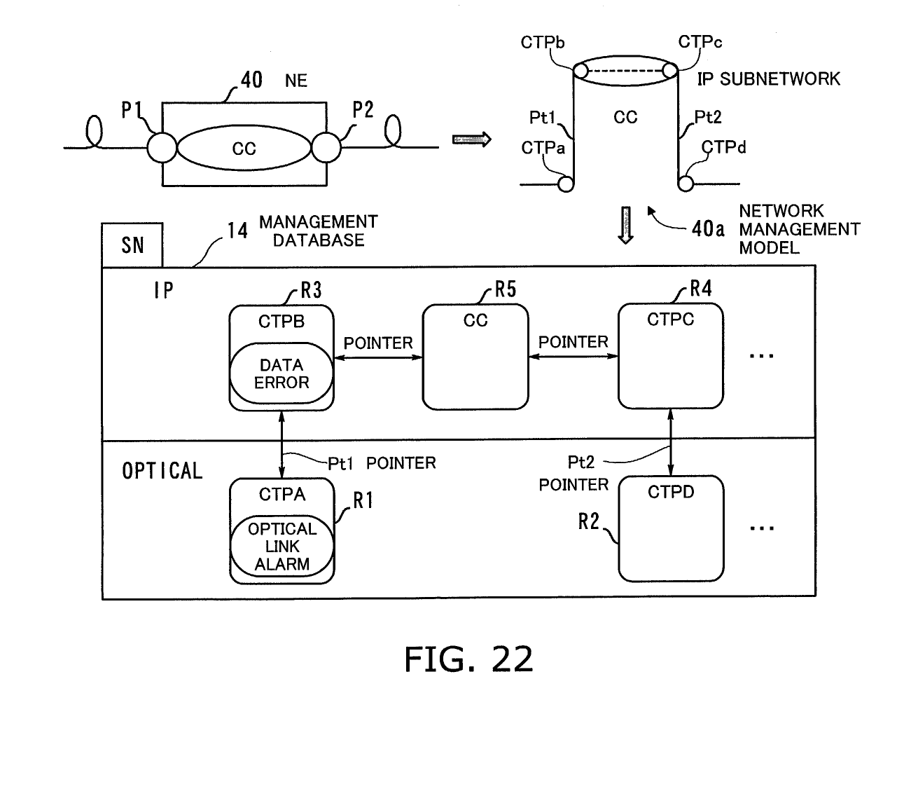

The fundamental elements constituting a network management model are called “component data objects.” CTPs are one type of component data objects. A series of operations for linking or delinking such component data objects is called “procedure data object.” The term “scenario” refers to a predefined set of component and procedure data objects prepared for the purpose of modeling a particular layer. The scenario manager 12 manages various scenarios to facilitate construction of a network management model. The constructed network management model is stored as managed objects of the network management model database 14 on an individual subnetwork basis, as will be discussed in FIG. 22 in greater detail.

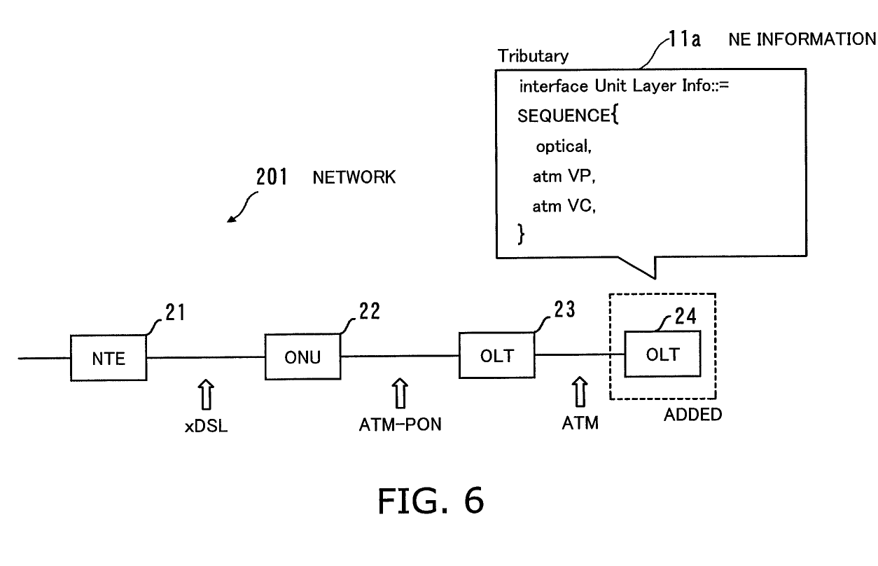

Referring now to FIG. 6, it is assumed that a new network element is added to the network 200 of FIG. 4. This addition causes a change in the network structure, necessitating an update to the current corresponding network management model 200m.

FIG. 6 shows a network 201 with a new element, OLT 24, added to the right-hand side of the existing OLT 23. Network element information (to be shortened as “NE information” or “NE info” where appropriate) of this OLT 24 includes configuration data of its lower, intermediate, and upper layers. While FIG. 6 only shows such network element information on the tributary side, the OLT 24 has similar data for the trunk side. The tributary-side NE information 11a includes the following three layer descriptors, beginning with the lowest layer: “optical,” “ATM VP,” and “ATM VC.”

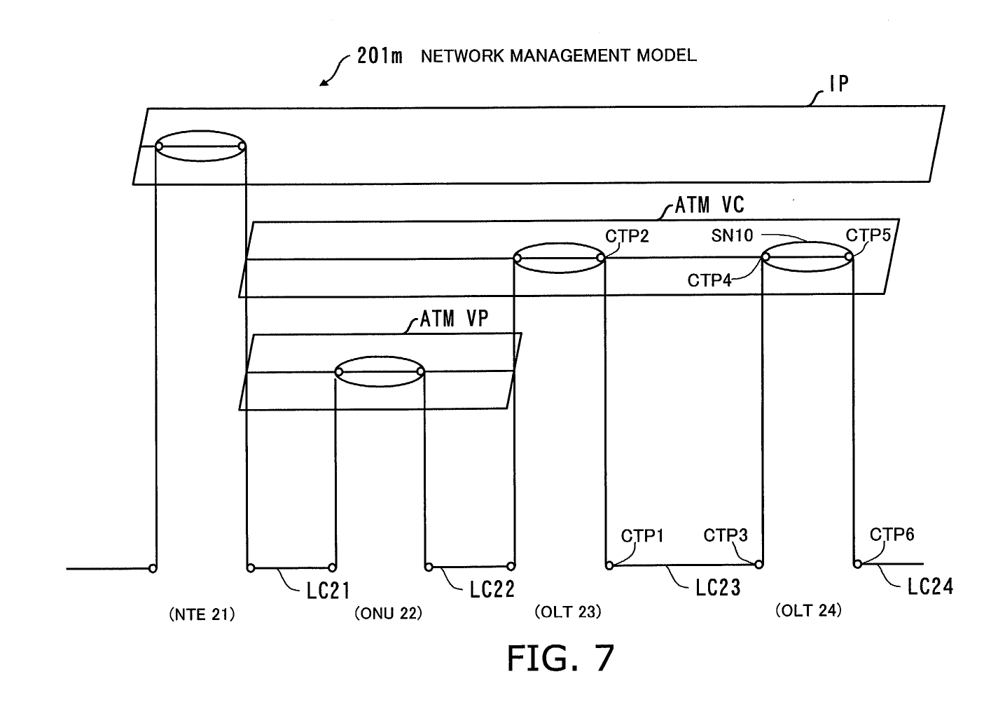

FIG. 7 shows an updated network management model 201m depicting the state after the network structure has changed. This model 201m represents the network 201 of FIG. 6, which now includes a new physical link connection LC24 for the OLT 24. The physical link connection LC23 interconnects the OLT 23 and OLT 24. The OLT 24 is managed in a subnetwork SN10 at ATM VC layer. Also established at that layer is a link connection between the NTE 21, OLT 23, and OLT 24.

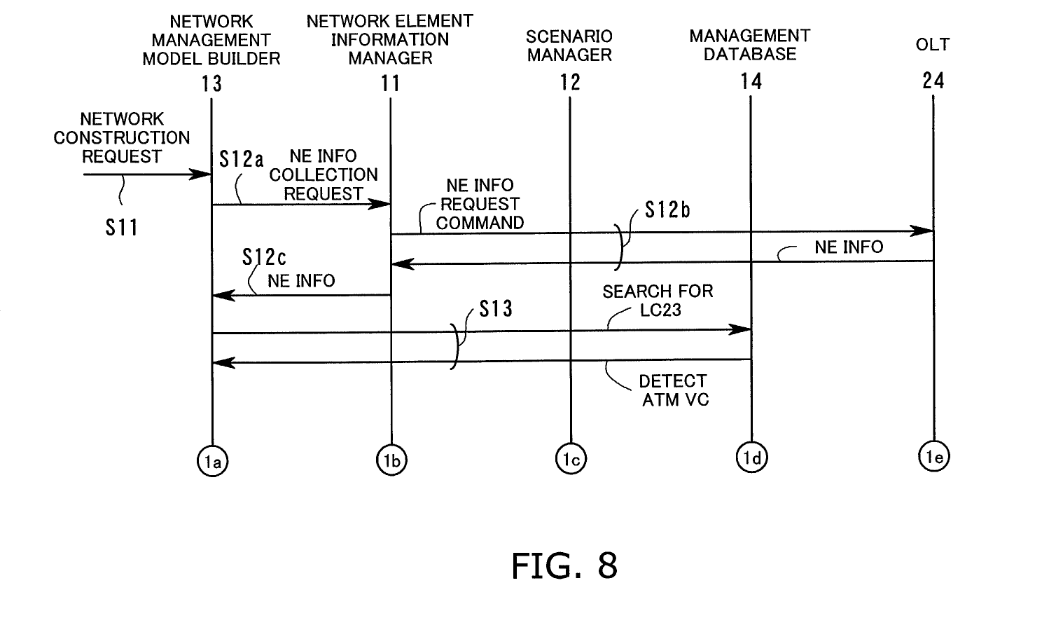

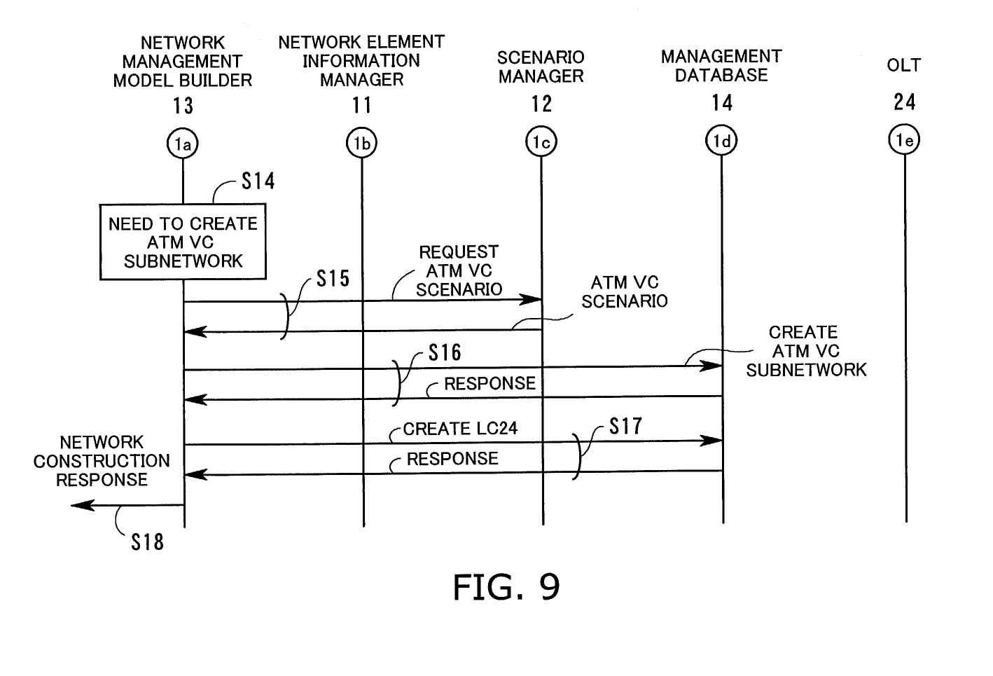

FIGS. 8 and 9 show a sequence diagram to explain how the network management model 201m is created. This procedure is executed as follows:

(S11) A higher-order management system (e.g., NMS) or an operator initiates a network construction request to the network management model builder 13.

(S12a) The network management model builder 13 then issues a network element information (“NE INFO” in FIG. 8) collection request to the network element information manager 11.

(S12b) The network element information manager 11 transmits a network element information request command to the OLT 24. In response to this command, the OLT 24 sends its own NE information 11a (i.e., “interface Unit Layer info” shown in FIG. 6) back to the requesting network element information manager

(S12c) The network element information manager 11 forwards the received NE information 11a to the network management model builder 13.

(S13) Upon receipt of the NE information 11a, the network management model builder 13 checks whether it would affect the current network management model 200m. Referring back to FIG. 5, the added OLT 24 will be connected to the open end of the existing link connection LC23. Accordingly, the network management model builder 13 requests the network management model database 14 (hereafter “management database” 14) to search for the record of LC23, in an attempt to find out which subnetwork is linked to the other end of that link connection LC23. As a result of this search, it turns out that one connection termination point CTP1 of LC23 is linked to CTP2 of the ATM VC subnetwork as shown in FIG. 5.

(S14) The network management model builder 13 examines the search result of step S13 in comparison with the NE information 11a, thus realizing that a new ATM VC subnetwork (a management model on the ATM VC layer) has to be created at the open end of the current link connection LC23 so as to accommodate the OLT 24.

(S15) The network management model builder 13 retrieves ATM VC scenario from the scenario manager 12. The ATM VC scenario contains CTPs (e.g., CTP3 to CTP6 in FIG. 7) and other component data objects, together with their associated procedure data objects.

(S16) The network management model builder 13 creates an ATM VC subnetwork SN10 (FIG. 7) and sends the resultant model to the management database 14. The management database 14 stores the received model, allocating an appropriate memory space to it.

(S17) The network management model builder 13 creates and adds a link connection LC24 (FIG. 7) to CTP6 for further device connection in the future. This link connection LC24 should also be included in the network management model in the management database 14.

(S18) When it has finished creating the updated network management model 201m, the network management model builder 13 sends a network construction response message to notify the higher-level system or operator of the completion of the requested task.

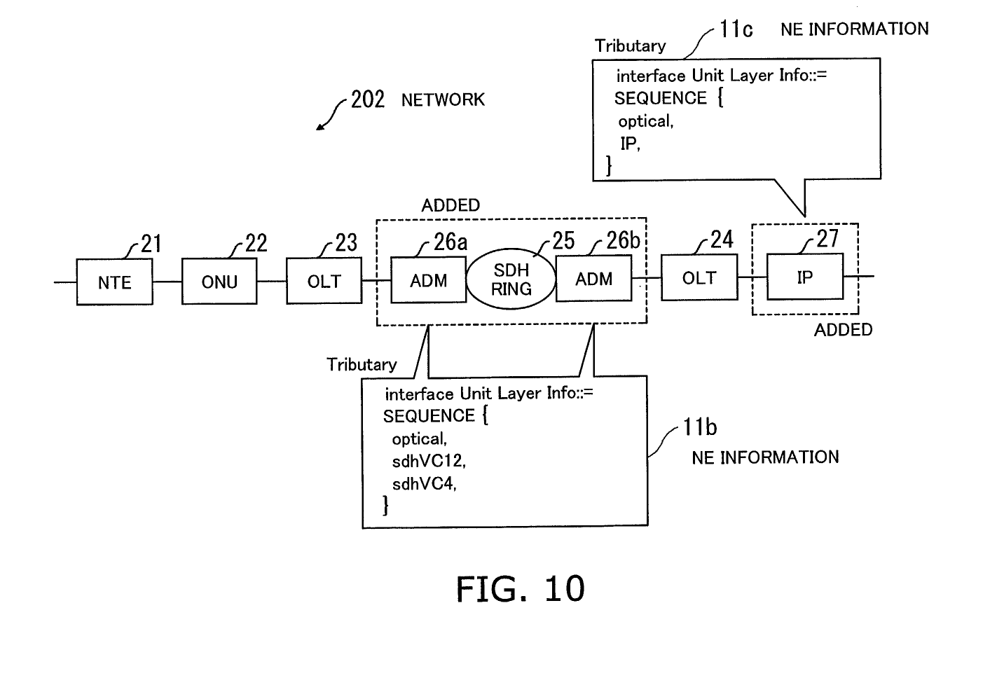

Referring next to FIG. 10, another example of network management operation will be described. FIG. 10 shows such a situation where an SDH ring network and an IP network device are added to the network 201 of FIG. 6. This addition causes a change in the network structure, necessitating an update to the current network management model 201m of FIG. 7.

Compared with the network 201 in the previous state, the illustrated network 202 has gained two add/drop multiplexers (ADM) 26a and 26b as part of an SDH ring network 25, as well as an IP network element 27. The first ADM 26a is coupled to the OLT 23, while the second ADM 26b is linked to one end of the OLT 24. The IP network element 27 is connected to the other end of the OLT 24.

The two ADMs 26a and 26b provides their tributary-side NE information 11b, indicating that they have a three-layer structure that begins with the lowest optical link layer, followed by SDH Virtual Container-12 (VC12) layer and then SDH VC4 layer. On the other hand, the IP network element 27 shows, in its tributary-side NE information 11c, that it is constructed with optical link layer and IP layer.

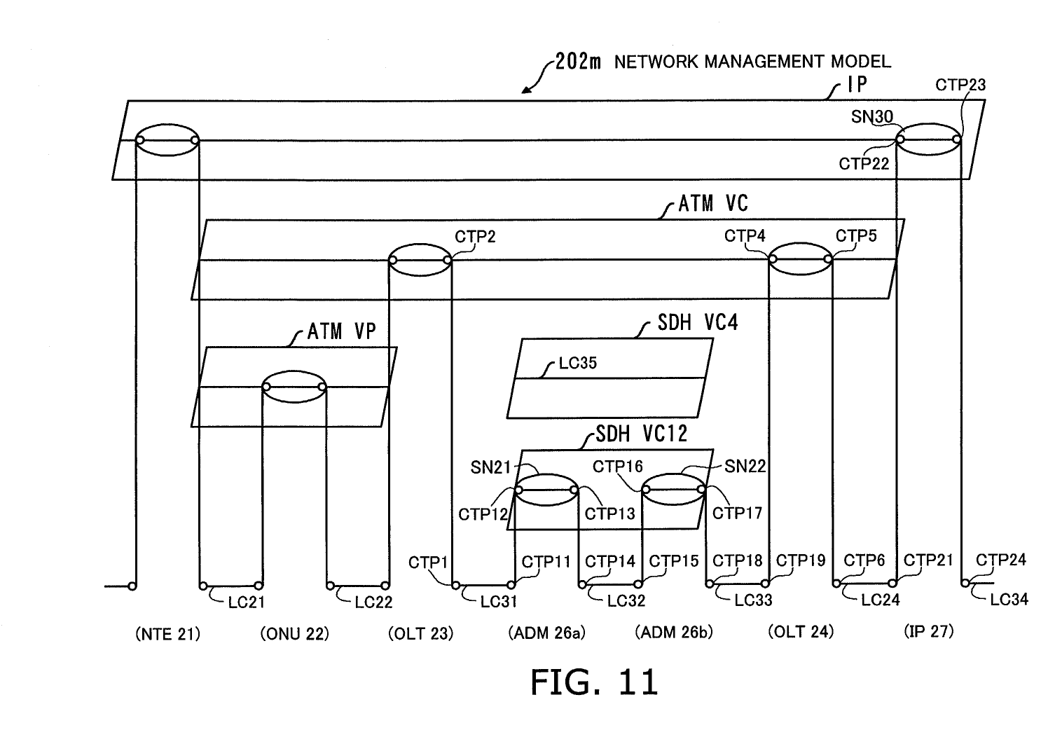

FIG. 11 shows an updated network management model 202m representing the network 202, which includes the structural changes made in FIG. 10. This new network management model 202m has discarded the link connection LC23 on the physical layer, which was attached to the OLT 23 in the previous version model 201m. Instead, it now has a new link connection LC31 between the OLT 23 and ADM 26a, another link connection LC32 between the two ADMs 26a and 26b, and still another link connection LC33 between ADM 26b and OLT 24. In addition, the existing link connection LC24 is used to connect the OLT 24 to one end of the IP network element 27, and a yet another new link connections LC34 is attached to the other end of the IP network element 27. All the link connections mentioned above are at the physical layer.

The ADMs 26a and 26b are both managed in their respective SDH VC12 subnetworks SN21 and SN22. Further, the ADMs 26a and 26b has a link connection LC35 established on the SDH VC4 layer. The IP network element 27, on the other hand, is managed in an IP subnetwork SN30.

At the ATM VC layer, there are link connections established between the NTE 21, OLT 23, OLT 24, and IP network element 27. The NTE 21 and IP network element 27 has a link connection at the IP layer, as well.

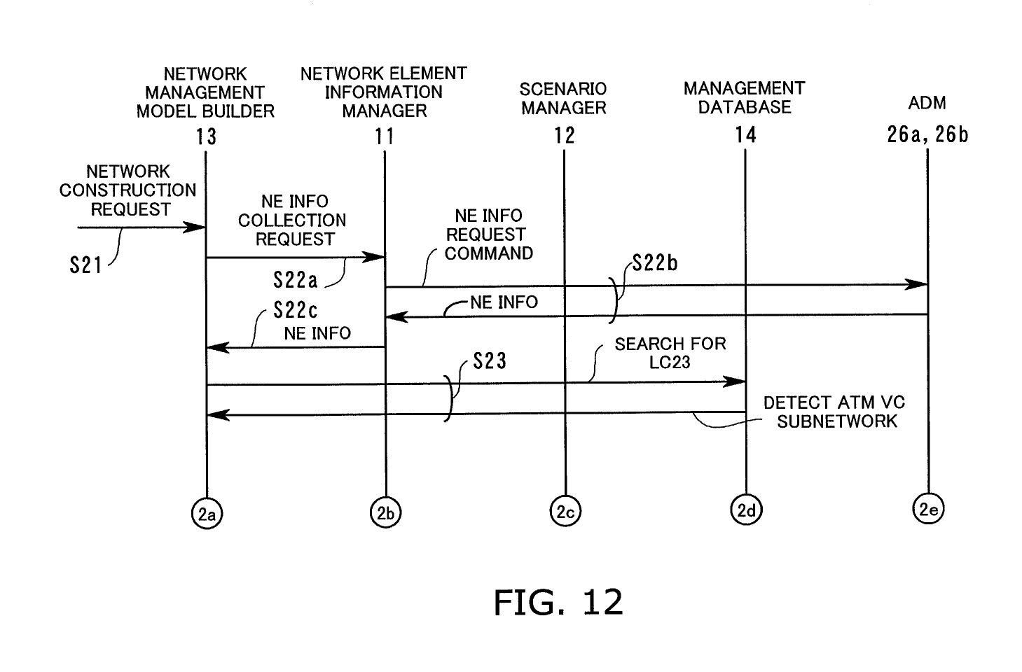

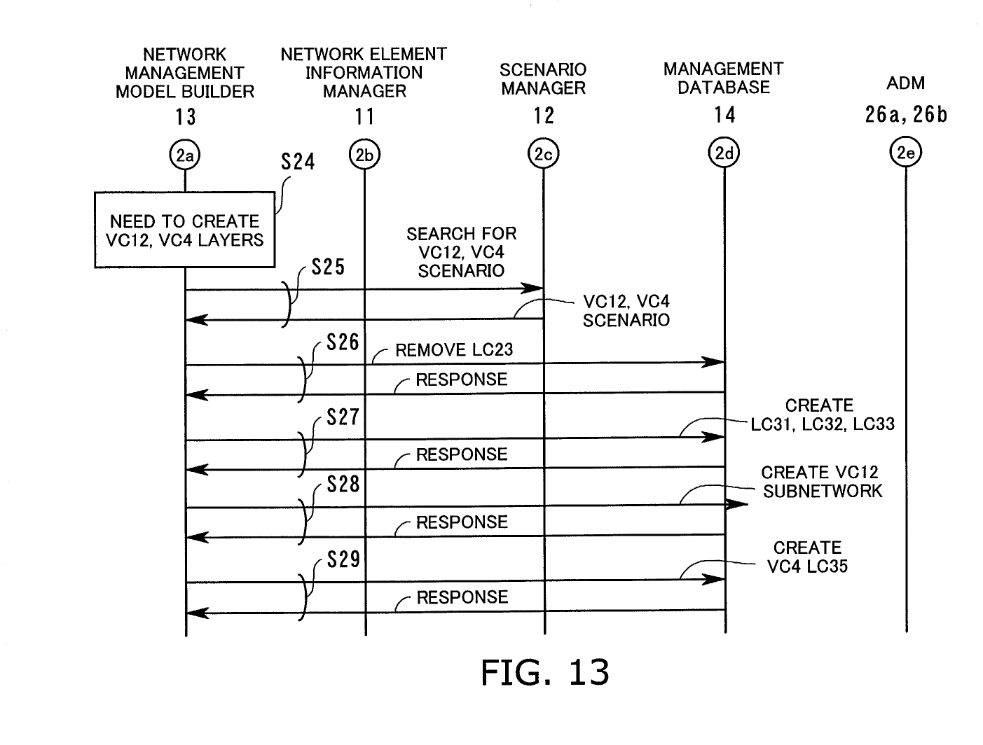

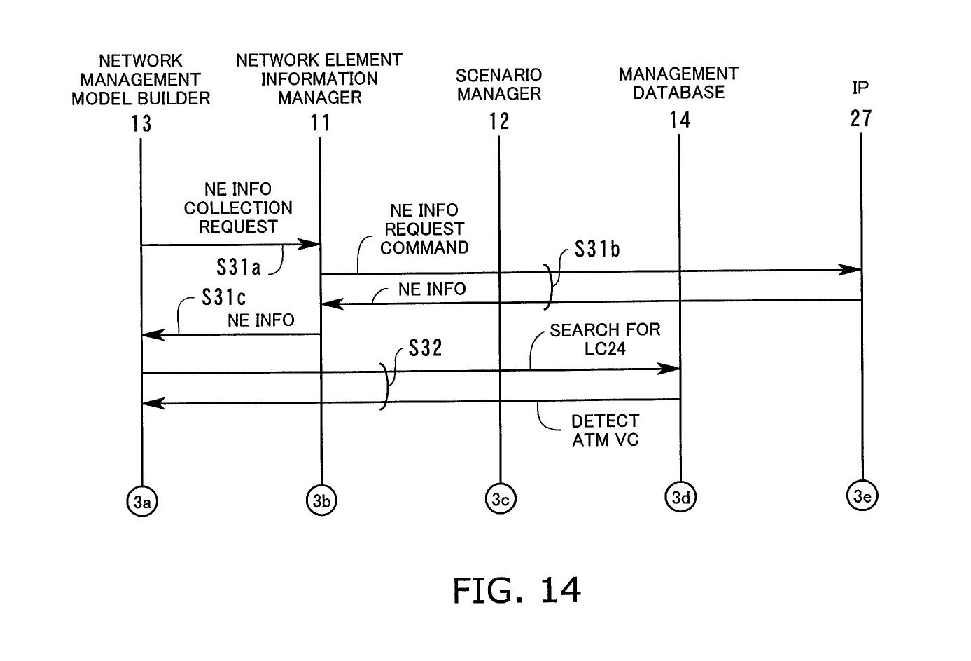

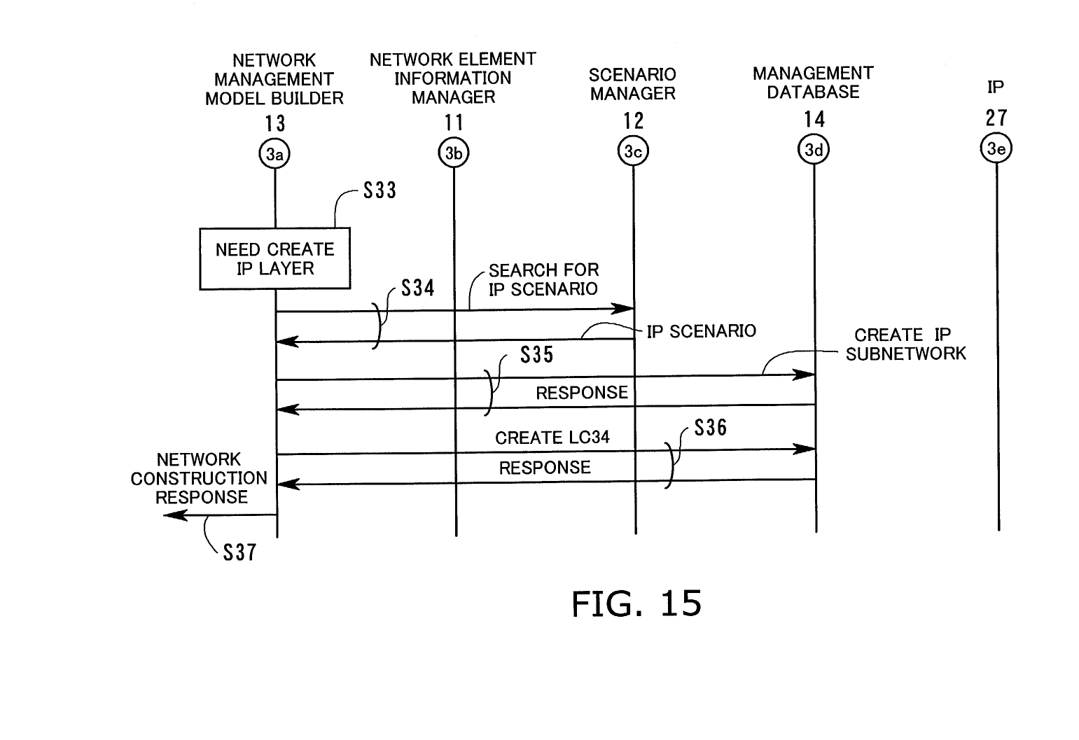

The new network management model 202m described above is produced through a series of interactions shown in the sequence diagram of FIGS. 12 to 15. The process is broadly divided into two parts: addition of the ADMs 26a and 26b (FIGS. 12 and 13) and that of the IP network element 27 (FIGS. 14 and 15).

(S21) A higher-order management system or an operator initiates a network construction request to the network management model builder 13.

(S22a) The network management model builder 13 sends a network element information collection request to the network element information manager 11, inquiring about the ADMs 26a and 26b.

(S22b) The network element information manager 11 sends a network element information request command to the ADMs 26a and 26b. They responds to the request by returning their NE information 11b (FIG. 10, “interface Unit Layer info”).

(S22c) The network element information manager 11 forwards the received NE information 11b to the network management model builder 13.

(S23) Upon receipt of the NE information 11b, the network management model builder 13 checks whether it would affect the current network management model 201m. As FIG. 7 shows, the ADMs 26a and 26b are to be inserted in place of the existing link connection LC23 between the two OLTs 23 and 24. Accordingly, the network management model builder 13 requests the management database 14 to search for the record of that link connection LC23, in an attempt to find out which subnetwork is currently linked to each end of LC23.

The above search reveals that the link connection LC23 is connected to CTP2 of the first ATM VC subnetwork at one end (CTP1) and to CTP4 of the second ATM VC subnetwork at the other end (CTP3), as shown in FIG. 7.

(S24) The network management model builder 13 examines the search result of step S23 in comparison with the NE information 11b. As a result of this analysis, it realizes that there exists an ATM VC layer above the physical layer in the section between the OLTs 23 and 24 (i.e., at both ends of the link connection LC23), but neither SDH VC12 nor SDH VC4 layer is available between the two layers, meaning that some management models of such missing layers have to be created.

(S25) The network management model builder 13 retrieves VC12 and VC4 scenarios from the scenario manager 12.

(S26) The network management model builder 13 deletes the link connection LC23 from the network management model 201m and updates the management database 14 accordingly.

(S27) The network management model builder 13 creates new link connections LC31, LC32, and LC33 and updates the management database 14 accordingly.

(S28) The network management model builder 13 creates two SDH VC12 subnetworks SN21 and SN22 as shown in FIG. 11. It sends the resultant model to the management database 14, which allocates an appropriate memory space to store the received model.

(S29) The network management model builder 13 creates an SDH VC4 link connections LC35 (FIG. 11) and updates the management database 14 accordingly.

(S31a) Separately from the above steps, the network management model builder 13 sends a network element information collection request to the network element information manager 11, inquiring about the IP network element 27.

(S31b) The network element information manager 11 sends a network element information request command to the IP network element 27. The IP network element 27 responds to the request by returning its NE information 11c (FIG. 10, “interface Unit Layer info”).

(S31c) The network element information manager 11 forwards the received NE information 11c to the network management model builder 13.

(S32) Upon receipt of the NE information 11c, the network management model builder 13 checks whether it would affect the current network management model 201m. Referring to FIG. 7, the IP network element 27 will be newly added to the open end of the existing link connection LC24. Accordingly, the network management model builder 13 requests the management database 14 to search for the record of LC24 in an attempt to find out which subnetwork is currently linked to the other end of that link connection LC24. This search reveals that the connection termination point CTP6 of LC24 in question is linked to CTP5 of the ATM VC subnetwork as shown in FIG. 7.

(S33) The network management model builder 13 examines the search result of step S32 in comparison with the NE information 11c, thus realizing that a new management model has to be created above the ATM VC layer so as to connect the IP network element 27 with the OLT 24. This management model should be at the IP layer and linked to the remaining end of the link connection LC24.

(S34) The network management model builder 13 retrieves IP scenario from the scenario manager 12.

(S35) The network management model builder 13 creates an IP subnetwork SN30 as shown in FIG. 11. It sends the resultant model to the management database 14, which allocates an appropriate memory space to store the received model.

(S36) The network management model builder 13 creates and adds a link connection LC34 (FIG. 11) to CTP24 for further device connection in the future. This link connection LC34 should also be included in the network management model in the management database 14.

(S37) When it has finished updating the network management model 202m, the network management model builder 13 sends a network construction response message to notify the higher-level system or operator of the completion of the requested task.

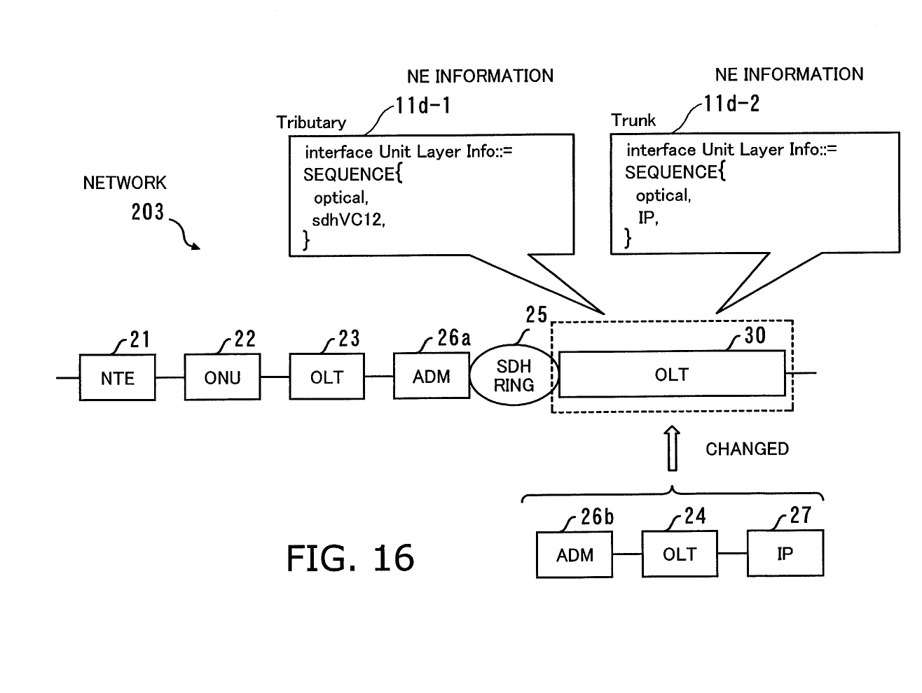

Referring next to FIGS. 16 to 20, another example of network management operation will be described. FIG. 16 shows such a situation where the ADM 26b, OLT 24, and IP network element 27 are replaced with a single OLT 30 having the functions equivalent to the three. This change in the network structure necessitates an update to the current network management model 202m of FIG. 11.

The OLT 30 in the modified network 203 provides its own structural information. Its tributary-side NE information 11d-1 shows its two-layer structure which begins with the lowest optical link layer, followed by SDH VC12 layer. Its trunk-side NE information 11d-2, on the other hand, shows that it is constructed with optical link layer and IP layer.

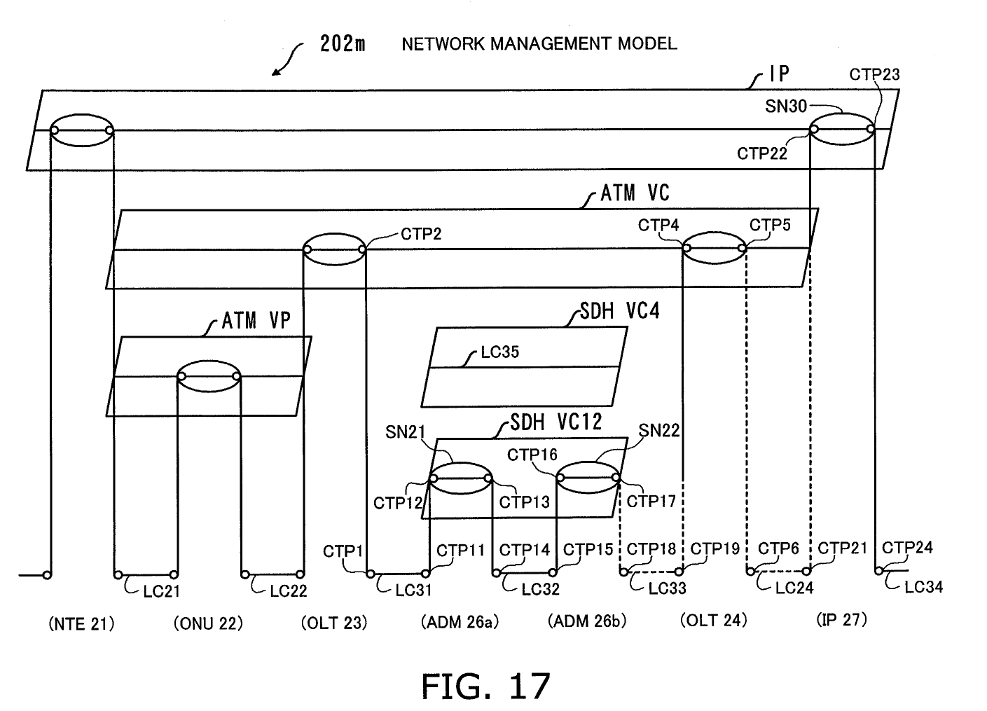

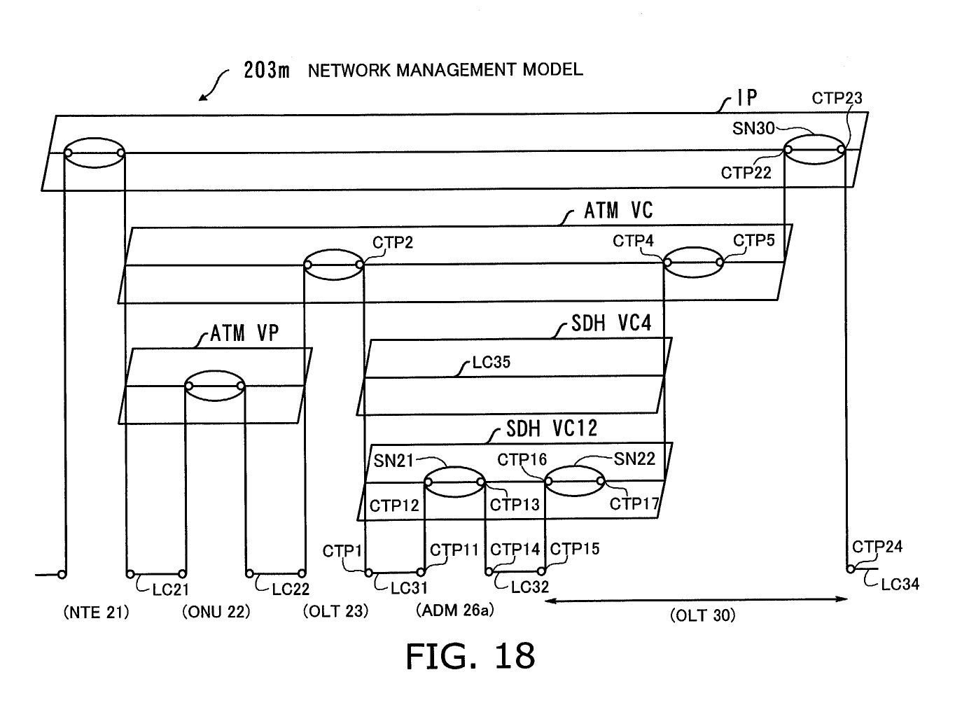

FIGS. 17 and 18 explain how the network management model is affected by the above change; the original model 202m is shown in FIG. 17 and the updated model 203m in FIG. 18.

Referring to FIG. 17, the broken lines represent local connections between the three elements to be deleted, (ADM 26b, OLT 24, and IP27). All the physical layer connections and CTPs on those broken lines will be removed, and instead, the OLT 30 will be inserted there.

FIG. 18 shows the resultant network management model 203m, in which the link connections LC33 and LC24 and connection termination points CTP18, CTP19, CTP6, and CTP21 have been deleted. The OLT 30 inherits the upper-layer structure from the previous elements, while some additional link connections are established between the two OLTs 23 and 30 at the SDH VC12 and SDH VC4 layers.

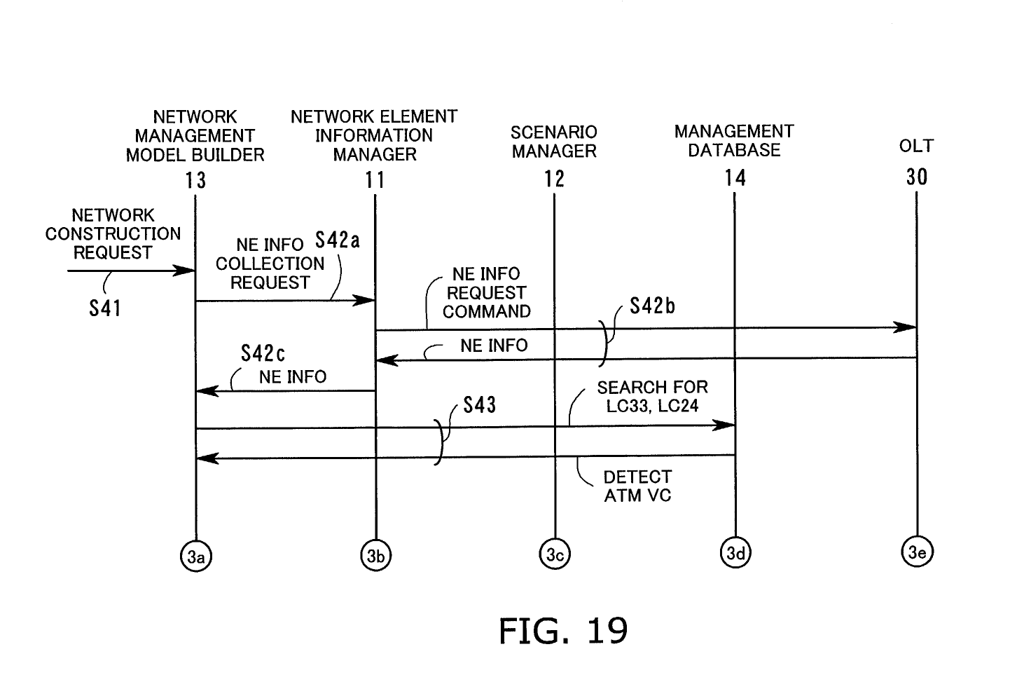

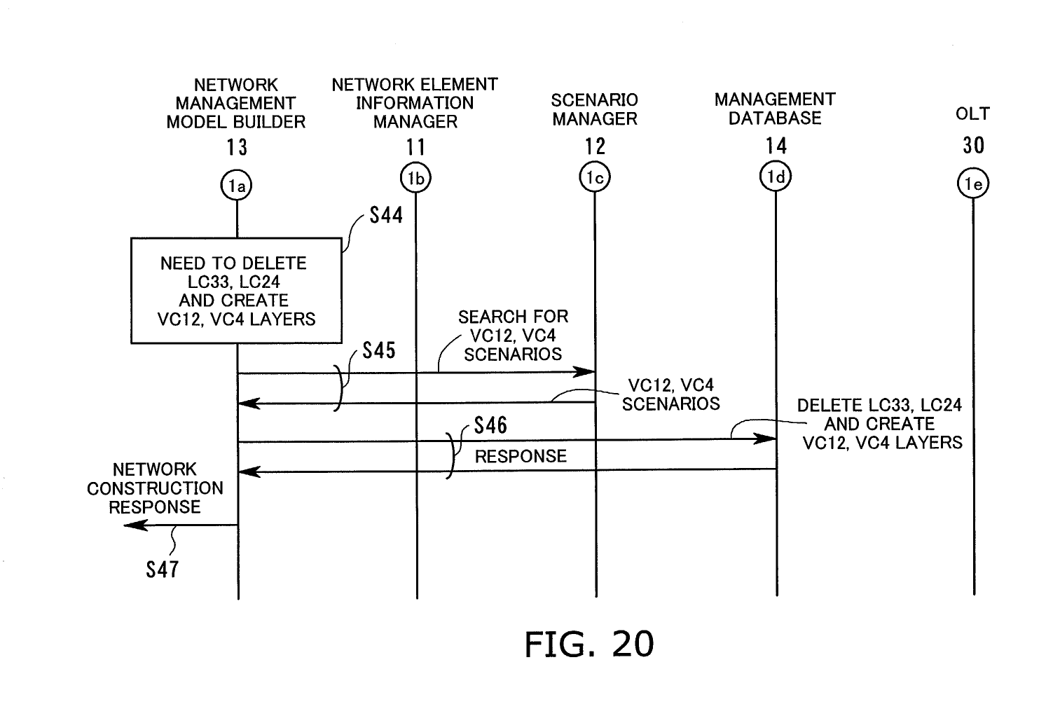

The new network management model 203m described above is produced through a series of interactions shown in the sequence diagram of FIGS. 19 and 20.

(S41) A higher-order management system or an operator initiates the transmission of a network construction request to the network management model builder 13.

(S42a) The network management model builder 13 sends a network element information collection request to the network element information manager 11, inquiring about the OLT 30 of interest.

(S42b) The network element information manager 11 transmits a network element information request command to the OLT 30. In response to this command, the OLT 30 sends its own NE information 11d-1 and 11d-2 (i.e., “interface Unit Layer info” shown in FIG. 16) back to the network element information manager 11.

(S42c) The network element information manager 11 forwards the received NE information 11d-1 and 11d-2 to the network management model builder 13.

(S43) Upon receipt of the network element information, the network management model builder 13 checks whether it would affect the current network management model 202m. As FIG. 17 shows, the OLT 30 is to be inserted in place of the existing link connections LC33 and LC24. Accordingly, the network management model builder 13 requests the management database 14 to search for the record of LC33 and LC24 of interest, in an attempt to find out which subnetwork is currently linked to each end of them.

The above search reveals that the link connection LC33 is connected to CTP17 of the second ATM VC12 subnetwork SN22 at one end (CTP17) and to CTP4 of the second ATM VC subnetwork at the other end (CTP19), as shown in FIG. 17. It has also turned out that the link connection LC24 is connected to CTP5 of the second ATM VC12 subnetwork at one end (CTP6), and to CTP22 of the IP subnetwork SN30 at the other end (CTP21), as shown in FIG. 17.

(S44) The network management model builder 13 examines the search result of step S43 in comparison with the NE information 11d-1 and 11d-2. It then realizes that some connections should be created at the SDH VC12 and SDH VC4 layers so as to accommodate the OLT 30, but the existing link connections LC33 and LC24 are no longer necessary.

(S45) The network management model builder 13 retrieves SDH VC12 and SDH VC4 scenarios from the scenario manager 12.

(S46) The network management model builder 13 creates connections at the SDH VC12 and SDH VC4 layers, while deleting the link connections LC33 and LC24. It sends the resultant model to the management database 14, which allocates an appropriate memory space to store the received model.

(S47) When it has finished creating the updated network management model 203m, the network management model builder 13 sends a network construction response message to notify the higher-level system or operator of the completion of its requested task.

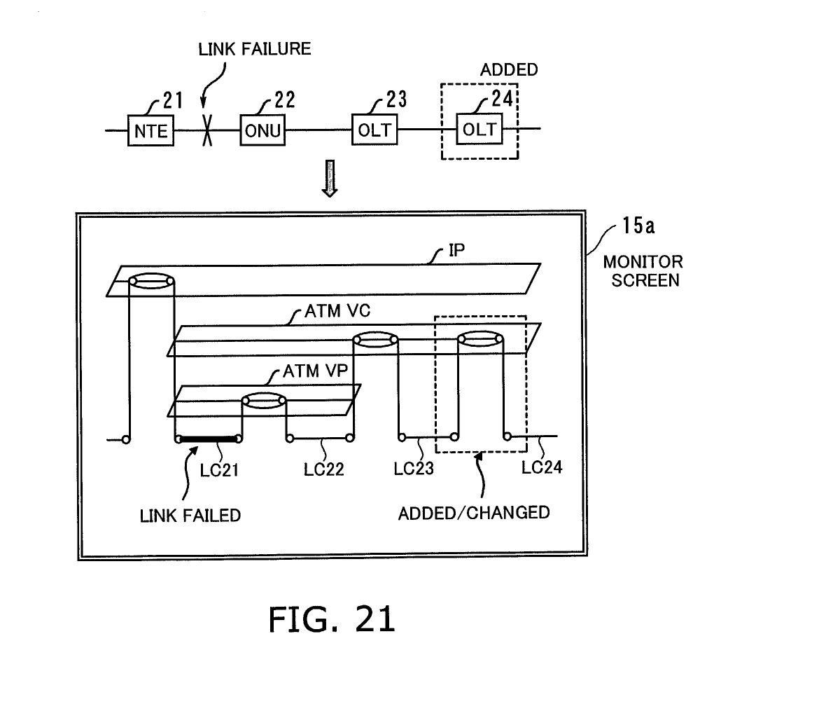

Referring now to FIG. 21, the function of the display controller 15 will be described below. The proposed network management unit 10 employs the display controller 15 to visualize the created network management model on a monitor screen of a relevant EMS or maintenance console. To help the user perform administrative tasks about the network, the displayed model indicates changes and failures (if any) within the network in a comprehensible way.

FIG. 21 shows an example of a monitor screen 15a produced by the display controller 15. It is assumed here that the network was initially made up of three cascaded network elements NTE 21, ONU 22, and OLT 23. The network has now gained a new OLT 24 next to the OLT 23. The monitor screen 15a shows the added OLT 24 distinguishably from other existing elements by drawing, for example, a dotted box to surround the added unit and connections, so that the user will easily identify the change. When a link failure occurs between the NTE 21 and ONU 22, the display controller 15 shows the location of the failed physical-layer link LC21, emphasizing it by using a red color, for example.

Referring next to FIG. 22, the management database (network management model database) 14 will be described below. FIG. 22 shows a network element 40 and its corresponding record in the management database 14. This network element 40 has an input and output ports P1 and P2 to accommodate physical optical links, and handles IP packets propagating over the links.

The management database 14 stores a network management model 40a for the network element 40 in the form of resource objects. That is, the data components constituting the network management model 40a are represented as objects and their associations. A particular network element is managed as a subnetwork (SN), which is a collection of such associated objects.

In the present example, the network element 40 is managed by being divided into optical layer and IP layer. The optical layer contains two resource objects R1 and R2, the former being a connection termination point object CTPa (port P1, actually) and the latter being another CTP object CTPd (port P2). The IP layer, on the other hand, contains three resource objects R3 to R5. The first two resource objects R3 and R4 are CTP objects CTPb and CTPc. The third resource object R5 is a cross connection (CC) object which interconnects CTPb and CTPc, which is actually an interface block between the ports P1 and P2.

The interface between resource objects is represented by pointers (or memory addresses). Take CTPa and CTPb for example. There is a pointer Pt1 between them, meaning that the resource objects R1 and R2 interact with each other, using that pointer Pt1. Likewise, CTPd and CTPc are linked together by a pointer Pt 2, meaning that the resource objects R2 and R4 interact with each other, using that pointer Pt2. (When depicting a network management model, the display controller 15 visualizes the pointers as line segments interconnecting CTPs.)

As seen from the above, the management database 14 maintains a network management model as a collection of resource objects on an individual subnetwork basis. When a change is made to the network structure, the management database 14 adds new resource objects and pointers at each layer. When a failure occurs in the link on the side of port P1, an optical link alarm is raised and its details are written into the resource object R1. Likewise, when an error is found in an IP datagram arriving at port P1, a data error will be indicated and its details are written into the relevant resource object R3.

The above discussion will now be summarized as follows. According to the present invention, the network management unit 10 builds and updates a network management model in an automated way, using relevant scenarios that are selected on the basis of network element information describing layer structure of each network element. In this way, the proposed network management unit produces a network management model automatically from collected network element information and selected scenarios. It enables network engineers to configure the network quickly through simple operations, without the need for obtaining detailed knowledge of network parameters.

In addition to product cost and quality, considerations for easy integration, interoperation, and maintenance are also important factors in designing network systems. Engineers have faced those challenges in an attempt to introduce sophisticated network functions and technologies. The proposed network management unit 10 provides them with a comprehensive management model that encompasses the network of interest, thus permitting them to perform global optimization of the entire network, as opposed to local optimization of a particular subsystem.

The functions of the above-described network management unit 10 are provided in the form of software programs, which includes computer instructions to cause an appropriate computer (server) platform to serve the intended management functions. This program is stored in a computer-readable medium, including magnetic storage media and semiconductor memory devices. Portable storage media, such as CD-ROMs and floppy disks, are suitable for circulation purposes. Further, it is possible to distribute programs from an appropriate server computer to other computers over a network. Users download a program file and install it in their computer's hard drive or other local mass storage device, which will be executed after being loaded to the main memory.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A network management unit which manages configuration of a network, comprising:
a network element information manager which collects and manages network element information, including layer structure of each network element;
a scenario manager which manages scenarios for use in building a model of the network;
a network management model builder which builds and updates a network management model automatically in response to a network construction request, consulting the network element information in conjunction with the scenarios; and
a network management model database which stores and manages the network management model.

2. The network management unit according to claim 1, wherein said scenario manager manages the scenarios each containing:
component data objects which represent fundamental elements constituting the network management model; and
a procedure data object which describes a series of operations for linking or delinking the component data objects.

3. The network management unit according to claim 1, wherein:
the network construction request includes a change to be made to a particular point at physical layer of the network; and
said network management model builder searches the network management model to find what is currently connected to the particular point, examines the result of the search in comparison with the network element information, and if the change affects the network management model, updates the network management model, using the relevant scenario retrieved from the scenario manager.

4. The network management unit according to claim 1, further comprising a display controller which displays the network management model on a monitor screen, indicating a change or failure that has occurred in the network.

5. The network management unit according to claim 1, wherein said network management model database manages each network element in the network management model as a subnetwork that is defined according to the layer structure thereof, storing components of the network management model in the form of resource objects.

6. A program product for managing a network system, causing a computer system to perform the steps of:
(a) collecting and managing network element information, including layer structure of each network element;
(b) managing scenarios for use in building a model of the network;
(c) building and updating a network management model automatically in response to a network construction request, consulting the network element information in conjunction with the scenarios; and
(d) storing and managing the network management model.

7. The program product according to claim 6, wherein each of the scenarios managed in said managing step (b) contains:
component data objects which represents fundamental elements constituting the network management model; and
a procedure data object which describes a series of operations for linking or delinking the component data objects.

8. The program product according to claim 6, wherein:
the network construction request that includes a change to be made to a particular point at physical layer of the network; and
said building and updating step (c) searches the network management model to find what is currently connected to the particular point, examines the result of the search in comparison with the network element information, and if the change affects the network management model, updates the network management model, using the scenarios.

9. The program product according to claim 6, further comprising the step of displaying the network management model on a monitor screen, indicating a change or failure that has occurred in the network.

10. The network management program according to claim 6, wherein said storing and managing step (d) manages each network element in the network management model as a subnetwork that is defined according to the layer structure thereof, storing components of the network management model in the form of resource objects.
